(19) United States
(12) Patent Application Publication
(10) Pub. No.: US 2018/0275939 A1
(43) Pub. Date: Sep. 27, 2018

(54) IMAGE FORMING APPARATUS, CONTROL METHOD OF IMAGE FORMING APPARATUS, AND STORAGE MEDIUM

(71) Applicant: CANON KABUSHIKI KAISHA, Tokyo (JP)

(72) Inventor: Yasunori Kanai, Nagareyama-shi (JP)

(21) Appl. No.: 15/909,102

(22) Filed: Mar. 1, 2018

(30) Foreign Application Priority Data
Mar. 23, 2017 (JP) 2017-058088

(51) Int. Cl. G06F 3/12

(52) U.S. Cl. CPC G06F 3/1294; G06F 3/1259; G06F 3/1274; G06F 3/1238; G06F 3/1217

(57) ABSTRACT

In an image forming apparatus that operates in a hold printing mode, it is possible to appropriately notify the side of a PC of the job state of a print job for which secure printing setting has been performed. An image forming apparatus that receives print data from an external device and notifies the external device of a processing status of the print data and is capable of registering the print data so as to be capable of starting image formation based on the print data by printing instructions from a user and of notifying the external device of a first processing status of the print data in accordance with completion of the registration, the image forming apparatus including: a unit configured to, in a case of performing the registration for specific print data, notify the external device of a second processing status different from the first processing status.

### BACKGROUND OF THE INVENTION

### Field of the Invention

The present invention relates to an image forming apparatus, a control method of an image forming apparatus, and a storage medium, and particularly, relates to an image forming apparatus capable of performing hold printing in which a print job is held temporarily, a control method of an image forming apparatus, and a storage medium.

### Description of the Related Art

Conventionally, there is a function to start printing, called secure printing, by transmitting a print job to which a password is attached to an image forming apparatus and inputting the password from an operation unit of the image forming apparatus (see Japanese Patent Laid-Open No. 2000-76028). This function is used at the time of printing of a confidential document and the like because it is possible to obtain output printed matter without being seen by another person.

On the other hand, in an environment in which a plurality of persons shares an image forming apparatus, as a function to prevent output printed matter from being left on the image forming apparatus, a hold printing function (hereinafter, also referred to simply as hold printing) has been proposed. The hold printing is a function to hold a print job in a storage area on the side of the image forming apparatus and a user selects a held print job from the operation unit of the image forming apparatus and gives printing instructions. With the hold printing, it is possible to implement a more flexible printing flow because printing setting (specification of number of copies, specification of both-side printing, and so on) can be changed on an operation panel of the image forming apparatus, in addition to that output printed matter is not seen by another person.

The image forming apparatus notifies the side of a PC (Personal Computer) that has input a print job of the state of the print job (hereinafter, referred to as a job state). At this time, along with the job state, a job ID that is identification information on the print job is notified. Due to this, on the side of the PC, it is made possible to monitor the job state of each input print job. Normally, the job state moves in the order of “processing start waiting” indicating that the image forming apparatus has received a print job, “processing in progress” indicating that printing is in progress, and “completed” indicating completion of printing. In the case where a print job for which secure printing setting has been performed (hereinafter, referred to as a secure print job) is received, the image forming apparatus puts execution of printing on standby until a password is input via the operation unit. Because of this, in the case where a secure print job is received, the job state enters “temporary suspension” after “processing start waiting” and after a password is input, the job state moves to “processing in progress”.

In the case where the hold printing function of the image forming apparatus is effective, the image forming apparatus temporarily terminates a print job and sets the job state to “completed” at the point in time of print data of the received print job being stored in the storage area. Then, for a print job whose job state is set to “completed” as described above, no job ID is held and a job ID is allocated newly in the case of receiving printing instructions from a user. Because of this, in the case where the hold printing function of the image forming apparatus is effective, it is difficult for the side of the PC to monitor a print job continuously from job input until completion of printing. However, for a secure print job, from the viewpoint of security, it is desired to be capable of monitoring the print job continuously from job input until completion of printing.

Consequently, an object of the present invention is to provide an image forming apparatus capable of appropriately notifying the side of a PC of the job state of a print job for which secure printing setting has been performed even in the case where the image forming apparatus is operating in a hold printing mode.

### SUMMARY OF THE INVENTION

The image forming apparatus according to the present invention is an image forming apparatus that receives print data from an external device and notifies the external device of a processing status of the print data and is capable of registering the print data so as to be capable of starting image formation based on the print data by printing instructions from a user and of notifying the external device of a first processing status of the print data in accordance with completion of the registration, the image forming apparatus including: at least one controller having a processor that executes programs stored in a memory or a circuitry having functions implemented therein, the at least one controller being configured to function as: a unit configured to, in a case of performing the registration for specific print data, notify the external device of a second processing status different from the first processing status.

Further features of the present invention will become apparent from the following description of exemplary embodiments with reference to the attached drawings.

### BRIEF DESCRIPTION OF THE DRAWINGS

FIG. 1 is a diagram showing an example of a configuration of a printing system including an image forming apparatus according to a first embodiment of the present invention;

FIGS. 2A and 2B are each a diagram showing an example of a printing setting screen that is displayed on a display unit of a PC;

FIG. 3 is a flowchart showing transmission processing of a print job, which is performed by a CPU of the PC;

FIGS. 4A to 4C are each a diagram showing a display example of a Print job monitor screen that is displayed on the display unit of the PC;

FIG. 5 is a flowchart showing reception processing of a print job, which is performed by a CPU of the image forming apparatus;

FIGS. 6A and 6B are each a diagram showing an example of a screen on which to set a hold printing mode;

FIG. 7 is a diagram showing an example of a screen on which to give instructions to print held print data;

FIG. 8 is a flowchart showing printing processing for held print data, which is performed by the CPU of the image forming apparatus;

FIG. 9 is a diagram showing an example of a password input screen;

FIGS. 10A and 10B are each a diagram showing a display example of a Print job monitor screen that is displayed on the display unit of the PC in the case where a secure print job is transmitted to the image forming apparatus according to the first embodiment;

FIG. 11 is a flowchart showing processing at the time of completion of printing of a print job, which is performed by a CPU of an image forming apparatus according to a second embodiment; and

FIG. 12 is a diagram showing an example of a reprinting screen.

### DESCRIPTION OF THE EMBODIMENTS

In the following, embodiments for embodying the present invention are explained by using the drawings. The configurations shown in the following embodiments are merely exemplary and the present invention is not limited to the configurations shown schematically.

### First Embodiment

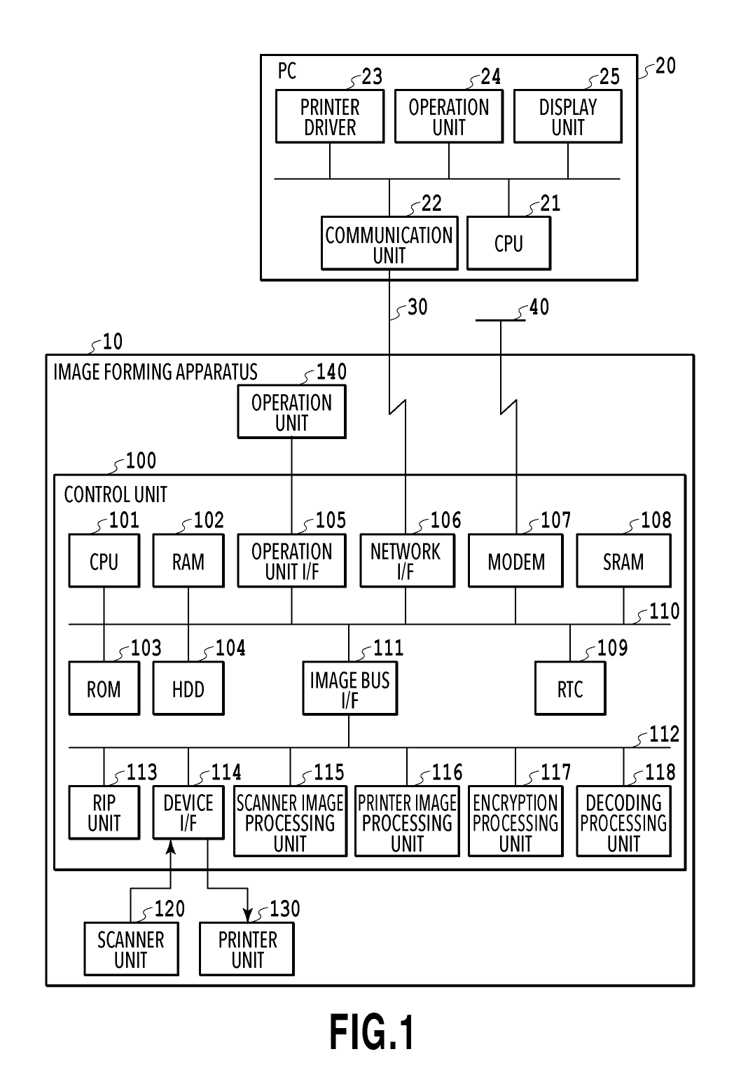

FIG. 1 is a diagram showing an example of a configuration of a printing system including an image forming apparatus according to a first embodiment of the present invention.

As shown in FIG. 1, a printing system 1 includes an image forming apparatus 10 and a PC 20. The image forming apparatus 10 and the PC 20 are connected by a network 30. The image forming apparatus 10 includes a control unit 100, a scanner unit 120, a printer unit 130, and an operation unit 140. The control unit 100 is connected with the scanner unit 120, which is an image input device, and the printer unit 130 configured to print an image on a printing sheet, and inputs and outputs image data and device information with those devices. Further, it is possible for the control unit 100 to input and output image data with the PC 20 connected via the network 30 and an external device connected via a public line 40. The control unit 100 includes a CPU 101, a RAM 102, a ROM 103, an HDD (Hard Disk Drive) 104, an operation unit interface (I/F) 105, a network I/F 106, a modem 107, an SRAM 108, and an RTC 109. These components are connected to one another via a system bus 110 within the control unit 100. The CPU 101 is a processor that controls the entire image forming apparatus 10. The RAM 102 is a system work memory for the CPU 101 to operate. The RAM 102 is also a memory to temporarily store image data, user information, passwords, and so on. The ROM 103 is a boot ROM and stores a boot program of the image forming apparatus 10. The HDD 104 stores system software, applications, image data, and so on. The HDD 104 also stores programs to perform flowcharts, to be described later. The operation unit I/F 105 is an interface with the operation unit 140 having a touch panel. The operation unit I/F 105 outputs image data to the operation unit 140 and displays an image on a display unit (not shown schematically) possessed by the operation unit 140. Further, the operation unit I/F 105 notifies the CPU 101 of information input to the operation unit 140 by a user. The network I/F 106 connects to the network 30 and inputs and outputs information. The modem 107 connects to the public line 40 and inputs and outputs information. The SRAM 108 is a volatile storage device capable of operating at a high speed, but in the present embodiment, the SRAM 108 operates as a storage device equivalent to a nonvolatile storage device by a backup power source. The RTC 109 is a real-time clock and continues to count the current time even in a state where the power source of the control unit 100 is off.

The control unit 100 further includes a RIP unit 113, a device I/F 114, a scanner image processing unit 115, a printer image processing unit 116, an encryption processing unit 117, and a decoding processing unit 118. These components are connected by an image bus 112 within the control unit 100. The image bus 112 and the system bus 110 are connected by an image bus I/F 111, which is a bus bridge that converts a data structure. The image bus 112 is a PCI bus. The RIP unit 113 is a raster image processor and develops PDL (Page Description Language) code into a bitmap image. The device I/F 114 connects the scanner unit 120 and the printer 130 with the control unit 100 and performs synchronous/asynchronous conversion of image data. The scanner image processing unit 115 performs image processing, such as correction, processing, and editing, for image data that is input from the scanner unit 120. The printer image processing unit 116 performs correction, resolution conversion, and so on, in accordance with the print engine of the printer unit 130 for the image data to be output to the printer unit 130. The encryption processing unit 117 performs encryption processing of input data including image data. The decoding processing unit 118 performs decoding processing of encrypted data.

The PC 20 includes a CPU 21, a communication unit 22, a printer driver 23, an operation unit 24, and a display unit 25. The CPU 21 controls the entire PC 20. The communication unit 22 is a NIC (Network Interface Card) to connect to the network 30. The printer driver 23 is a driver to control the image forming apparatus 10. The operation unit 24 is a keyboard, a mouse, and so on. The display unit 25 is a display device to present information to a user.

By the above configuration, it is possible for the image forming apparatus 10 to perform a print job to print an image on a printing sheet. Further, it is possible for a user to perform an operation relating to a print job. For example, it is possible for a user to transmit a print job to the image forming apparatus 10 from the PC 20 by operating the operation unit 24 of the PC 20. Further, it is possible for the image forming apparatus 10 to perform the above-described hold printing in which print data is temporarily stored (held) and printing of the print data is performed in response to printing instructions from a user. Transmitting a print job means, more specifically, the PC 20 transmitting print data to instruct the image forming apparatus 10 to perform a print job.

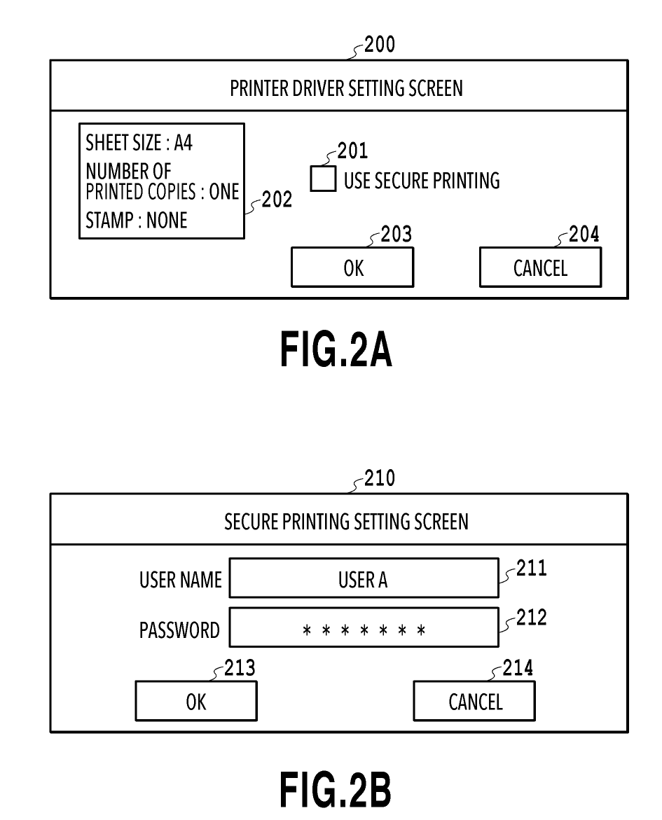

Next, transmission processing of a print job in the PC 20 is explained. FIGS. 2A and 2B are each a diagram showing an example of a printing setting screen that is displayed on the display unit 25 of the PC 20. FIG. 2A shows an example of a printer driver setting screen. FIG. 2B shows an example of a secure printing setting screen. It is possible for a user to perform setting of secure printing on the setting screens shown in FIGS. 2A and 2B. In the case where a secure print job is input to the image forming apparatus 10 from the PC 20, as described above, the job state remains “temporary suspension” until a correct password is input by a user. Then, in the case where a correct password is input, a state is brought about where it is possible to perform an operation relating to a print job (operation to start printing and the like). As described above, in secure printing, the security of a print job is kept by limiting printing by a password. As shown in FIG. 2A, a printer driver setting screen 200 includes a checkbox 201 to set secure printing effective or ineffective (whether or not secure printing is used) and a text checkbox 202 to display contents of setting relating to printing. The setting relating to printing is the sheet size, the number of printed copies, the presence/absence of stamp, and so on. The setting relating to printing can be set on a setting screen, not shown schematically.

In order to set secure printing effective, a user checks the checkbox 201 and presses down an OK button 203. Then, a secure printing setting screen 210 shown in FIG. 2B is displayed.

The secure printing setting screen 210 includes a text box 211 to input a user name and a text box 212 to input a password. It may also be possible to set the name of a user of the PC 20, which is acquired from the user information stored in the RAM 102, as a default value in the text box 211. Further, it may also be possible to set a default value in the text box 212 by the printer driver 23. In the case where an OK button 213 is pressed down, the contents set in the text boxes 211 and 212 are reflected. Then, the PC 20 transmits a print job in accordance with the contents set on the printer driver setting screen 200 and the secure printing setting screen 210.

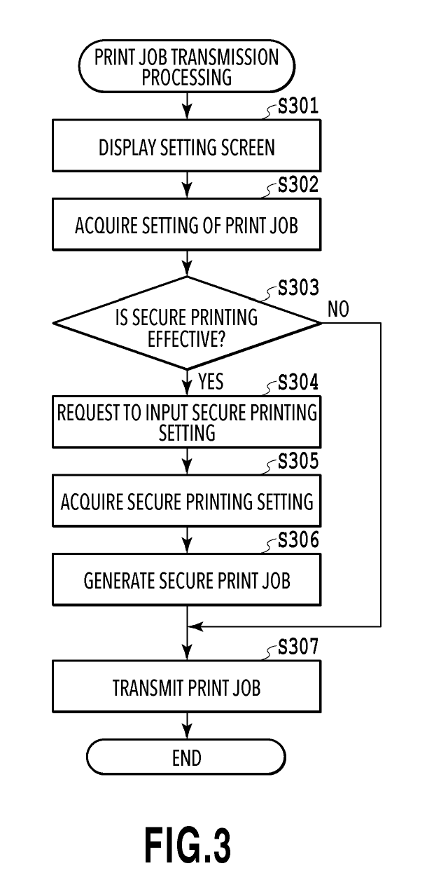

FIG. 3 is a flowchart showing transmission processing of a print job, which is performed by the CPU 21 of the PC 20. In the case where a user inputs instructions to display the printer driver setting screen 200, the operation unit 24 displays the printer driver setting screen 200 on the display unit 25 (step S301).

In the case where a user performs setting of a print job by operating the printer driver setting screen 200, the printer driver 23 acquires contents set on the printer driver setting screen 200 (step S302). Then, the printer driver 23 checks the ON/OFF state of the checkbox 201 and determines whether or not secure printing is effective (step S303).

In the case where secure printing is not effective (NO at step S303), the printer driver 23 transmits a normal print job, not a secure print job, to the image forming apparatus 10 (step S307) and terminates the processing.

On the other hand, in the case where secure printing is effective (YES at step S303), the printer driver 23 requests a user to input setting of secure printing (step S304). Specifically, the printer driver 23 displays the secure printing setting screen 210 on the display unit 25. In the case where a user operates the secure printing setting screen 210 and performs setting of authentication information (user name and password) used for user authentication of secure printing, the printer driver 23 acquires the setting contents (step S305). Then, the printer driver 23 adds a user name and a password to the print data in accordance with the acquired setting contents and generates a secure print job (step S306). The printer driver 23 transmits the generated secure print job to the image forming apparatus 10 as a print job (step S307) and terminates the processing.

In the above-described processing at step S306, as information that is added to print data, a user name is used, but it may also be possible to use another piece of identification information, such as a domain name of the PC 20 used by a user, in place of or in addition to a user name.

Here, the job state that the print job can take from the reception of a print job by the image forming apparatus 10 until completion of printing is explained. As described above, the job state includes the processing start waiting state, the temporary suspension state, the processing in progress state, and the completed state. The number of kinds of job state is not limited to four and for example, another state may be included in the job state. Hereinafter, there is a case where the processing start waiting state, the temporary suspension state, the processing in progress state, and the completed state are represented simply as processing start waiting, temporary suspension, processing in progress, and completed, respectively.

The “processing start waiting” is a state where a target print job has already become a candidate for which printing processing is to be started, but printing processing of the print job is not started yet. For example, this state corresponds to a state where there is another print job being in printing processing at the time of reception of a print job and the completion of processing of the other print job is awaited. The “temporary suspension” is a state where a target print job is excluded from the candidates for which printing processing is to be started for some reason, but in the case where the reason no longer exists, the state immediately moves to the “processing start waiting” and the print job becomes a candidate for which printing processing is to be started. For example, this state corresponds to a state of awaiting a password of a secure print job being input. The “processing in progress” is a state where printing processing of a target print job is being performed in the image forming apparatus 10. The “completed” is a state where printing processing of a target print job is completed.

The image forming apparatus 10 (CPU 101 of the image forming apparatus 10) sequentially transmits information indicating the job state of a print job (hereinafter, referred to as state information) to the PC 20, which is the source of transmission of the print job. In the present embodiment, the image forming apparatus 10 manages state information on a print job and a job ID that is allocated uniquely to the print job in association with each other. Then, the image forming apparatus 10 sequentially transmits screen information to display the state information along with the job ID on the display unit 25 of the PC 20. Due to this, a Print job monitor screen, to be described later, is displayed on the display unit 25 and it is made possible for a user to monitor the print job.

Normally, the number of print jobs that can be printed and performed at a time in the image forming apparatus is one. Consequently, even in the case where a plurality of print jobs is input to the image forming apparatus, the number of print jobs whose job state is “processing in progress” remains one. The job state of the other print jobs is one of “processing start waiting”, “temporary suspension”, and “completed”.

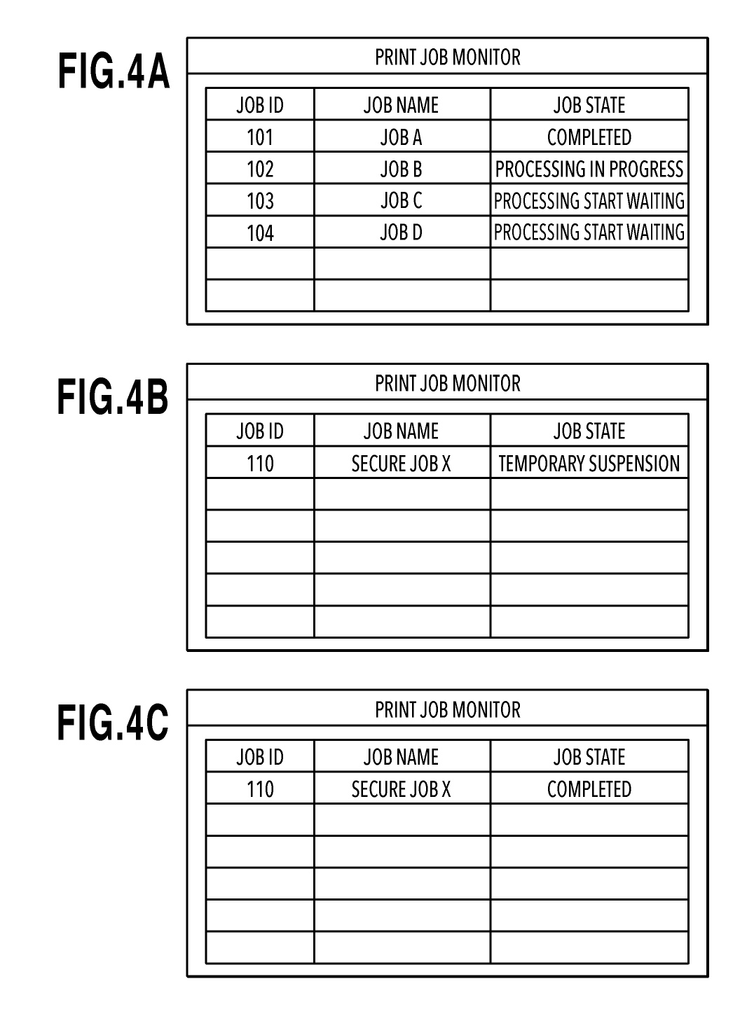

FIGS. 4A to 4C are each a diagram showing a display example of a Print job monitor screen that is displayed on the display unit 25 of the PC 20. FIG. 4A shows a display example of the Print job monitor screen in the case where a normal print job, not a secure print job, is transmitted to a conventional image forming apparatus not having the hold printing function. As shown in FIG. 4A, on the Print job monitor screen, the job state of a print job being in processing in the image forming apparatus is displayed. In a Job ID column on the Print job monitor screen, identification information (job ID) allocated uniquely to a print job in order to make it possible to manage the print job within the image forming apparatus 10 is displayed. In a Job name column, the name of a print job is displayed. In a Job state column, the job state of a print job is displayed. The print job that is displayed on the Print job monitor screen is a print job received by the image forming apparatus 10 and a print job for which printing processing has not been completed. For a print job for which printing processing has been completed, “completed” is displayed in the Job state column and this print job is deleted from the Print job monitor screen after a predetermined time.

FIG. 4B shows a display example of the Print job monitor screen in the case where a secure print job is transmitted to a conventional image forming apparatus not having the hold printing function. The image forming apparatus having received a secure print job puts execution of printing on standby until reception of a password input from a user and brings the job state of the secure print job to “temporary suspension”. Because of this, in the Job state column of the Print job monitor screen, “temporary suspension” is displayed.

FIG. 4C shows a display example of the Print job monitor screen in the case where a secure print job is transmitted to a conventional image forming apparatus having the hold printing function. Upon receipt of a print job, the image forming apparatus having the hold printing function registers the print data (stores in the storage area) and terminates the job. Such processing is also performed in the case where a secure print job is received. That is, the image forming apparatus stores the print data of a secure print job in the storage area and terminates the job. Because of this, in the Job state column on the Print job monitor screen, “completed” is displayed and this print job is deleted from the Print job monitor screen after a predetermined time elapses. That is, in the case where the image forming apparatus has the hold printing function, at the point in time at which the print data of the print job is stored in the image forming apparatus, which is the transmission destination of the print job, the job state becomes “completed”. Consequently, after this, it is no longer possible to check the job state from the image forming apparatus receiving a password input from a user until the printing processing is completed from the PC.

Because of this, in the present embodiment, in the case where the image forming apparatus 10 is operating in the hold printing mode, on a condition that the received print job is a secure print job, as will be described below, the job state is prevented from becoming “completed” even though the print data is stored in the storage area. Due to this, even in the case where the received print job is a secure print job, it is made possible to check the job state from the PC 20 until printing is completed.

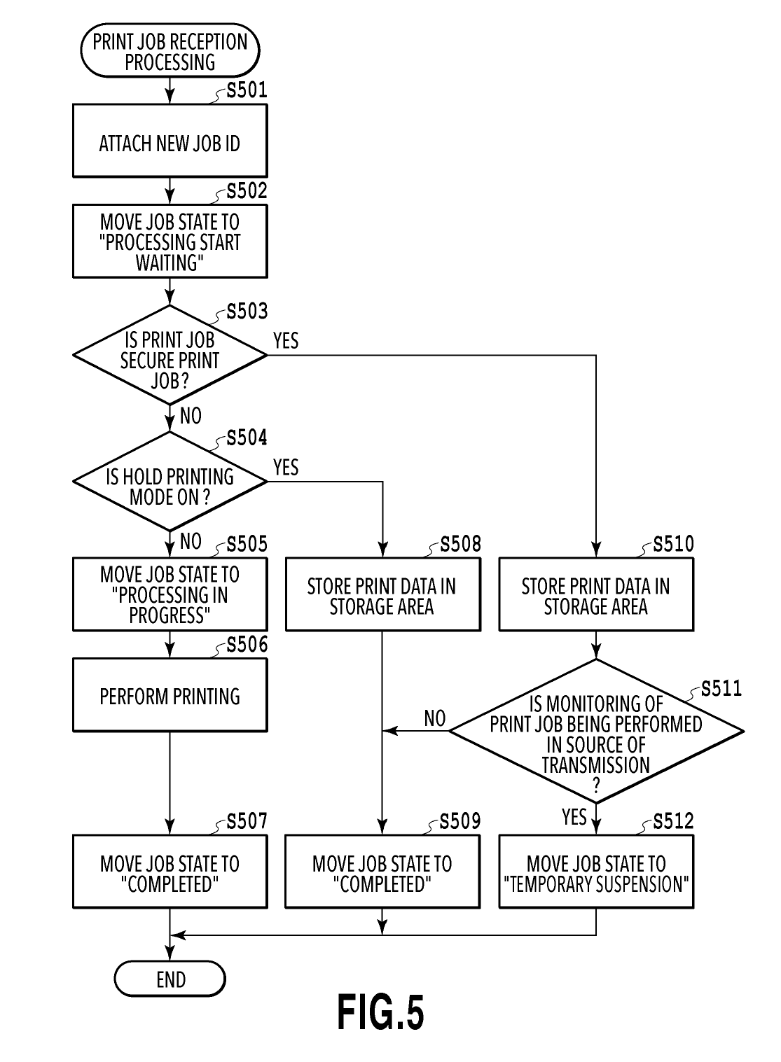

FIG. 5 is flowchart showing reception processing of a print job, which is performed by the CPU 101 of the image forming apparatus 10.

The CPU 101 attaches a new job ID to the received print job (step S501). Due to this, the PC 20 is notified of the job state along with the job ID, and therefore, it is made possible for the PC 20 to specify the print job corresponding to the notified job state.

Next, the CPU 101 starts analysis processing of the received print job and at the same time, sets the job state to “processing start waiting” (step S502). Next, the CPU 101 determines whether or not the received print job is a secure print job (step S503).

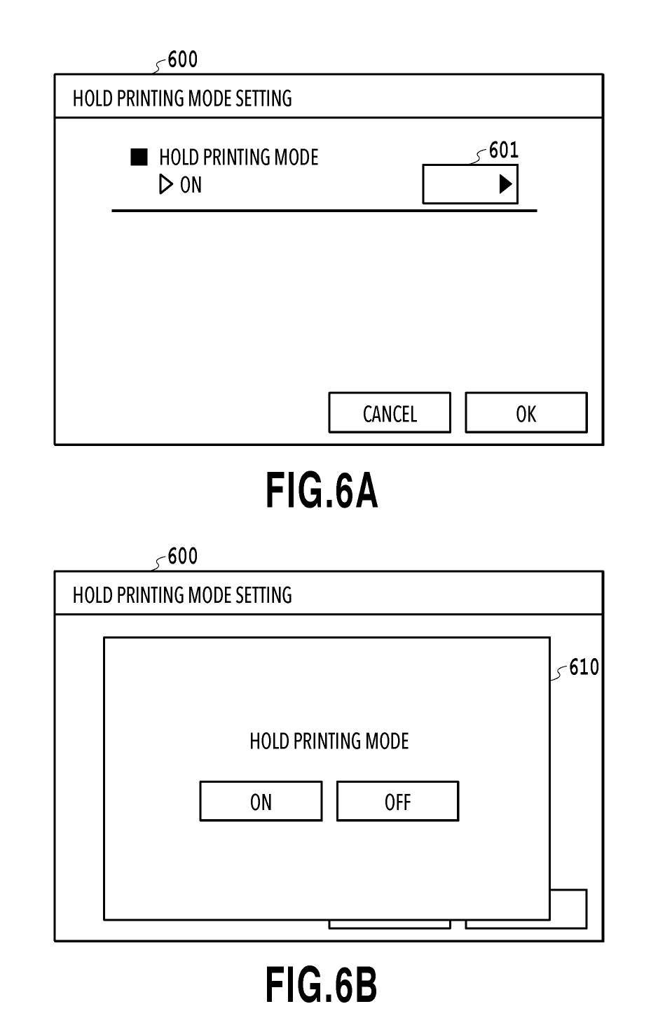

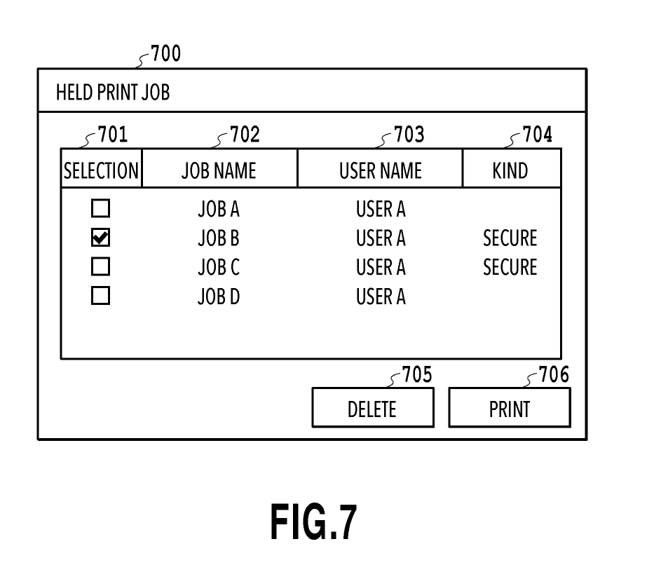

In the case where the received print job is not a secure print job (NO at step S503), the CPU 101 determines whether or not the hold printing function is set effective (whether or not the hold printing mode is set to ON) (step S504). It is possible to set switching between ON and OFF of the hold printing mode on a hold printing mode setting screen 600, for example, as shown in FIG. 6A. In the case of switching the hold printing mode, a hold printing mode switching screen 610 shown in FIG. 6B is displayed by a user pressing down an ON/OFF switching button 601, and therefore, it may be possible to switch between ON and OFF of the hold printing mode on the screen. On the hold printing mode setting screen 600, the current setting state of the hold printing mode is displayed. In the example shown in FIG. 6A, it is known that the hold printing mode is set to ON. In the case of performing printing processing for the held print data (print data stored in the storage area), a user selects the print data stored in the storage area from the operation unit 140 of the image forming apparatus 10 and gives printing instructions. A screen (hold printing screen) on which printing instructions are given to the held print data is shown in FIG. 7.

On a hold printing screen 700 shown in FIG. 7, a list of print data stored in the storage area of the image forming apparatus 10 is displayed. A Selection menu 701 is a checkbox to select print data to which printing instructions or deletion instructions are given. In Job name 702, a job name of held print data is displayed. In User name 703, a user name of held print data is displayed. In Kind 704, information indicating whether or not the print job is a secure print job is displayed. A Delete button 705 is a button to give deletion instructions to the print data selected in the Selection menu 701. A Print button 706 is a button to give printing instructions to the print data selected in the Selection menu 701.

In the case of determining that the hold printing mode is set to OFF (NO at step S504), the CPU 101 moves the job state to “processing in progress” (step S505) and performs printing processing of the print data. Then, on completion of the printing processing, the CPU 101 moves the job state to “completed” (step S507) and terminates the processing. As described above, in the case where the hold printing mode is set to OFF, on a condition that a normal print job that is not a secure print job is received, the image forming apparatus 10 moves the job state to “completed” after the printing processing is completed and terminates the processing.

In the case of determining that the hold printing mode is set to ON (YES at step S504), the CPU 101 stores the received print data in the HDD 104, which is a storage area (step S508). Then, the CPU 101 moves the job state to “completed” (step S509) and terminates the processing. As described above, in the case where the hold printing mode is set to ON, on a condition that a normal print job that is not a secure print job is received, the image forming apparatus 10 stores the print data in the storage area, moves the job state to “completed”, and terminates the processing.

In the case where the received print job is a secure print job (YES at step S503), the CPU 101 stores the print data of the received print job in the HDD 104, which is a storage area (step S510). Then, the CPU 101 determines whether or not monitoring of the print job is being performed in the PC 20, which is the source of transmission of the print job (step S511). It is possible to determine whether monitoring of the print job is being performed in the source of transmission of the print job based on, for example, the kind of protocol used for transmission and reception of the print job, in particular, based on the kind of printing application. More specifically, in the case where IPP or BMLinkS (registered trademark) is made use of in communication with the communication unit 22, it is possible to determine that monitoring of the print job is being performed in the PC 20 because those are printing applications that regard monitoring of a print job as important. Here, IPP is an abbreviation of Internet Printer Protocol.

In the case of determining that monitoring of the print job is not being performed (NO at step S511), the CPU 101 moves the job state to “completed” (step S509) and terminates the processing. In the case of determining that monitoring of the print job is being performed (YES at step S511), the CPU 101 moves the job state to “temporary suspension” (step S512) and terminates the processing. As described above, in the case of receiving a secure print job, on a condition that it is determined that monitoring of the print job is being performed in the source of transmission of the print job, the image forming apparatus 10 stores the print data in the storage area, moves the job state to “temporary suspension”, and terminates the processing.

It may also be possible to cancel the monitoring-target print job by instructions from the source of transmission of the print job. In that case, the image forming apparatus 10 (CPU 101) deletes the target print job upon receipt of cancel instructions (also referred to as stop instructions) from the source of transmission of the print job.

Further, it may also be possible for the CPU 101 to advance to the processing at step S512 without performing the determination processing at step S511 after performing the processing at step S510.

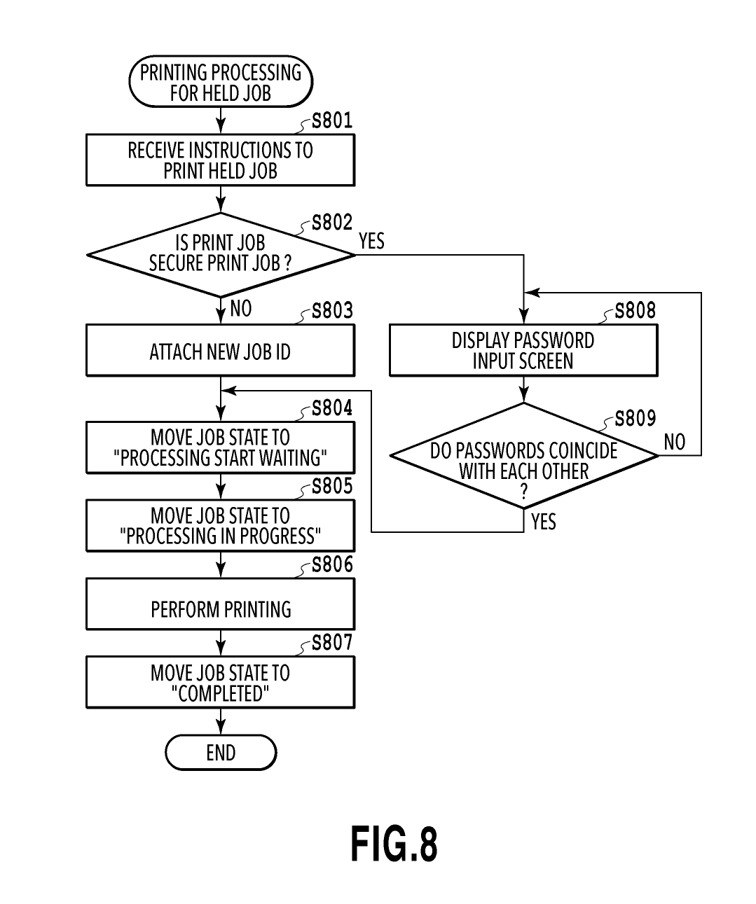

FIG. 8 is a flowchart showing printing processing for a held print job (also referred to as a held job), which is performed by the CPU 101 of the image forming apparatus 10.

The CPU 101 receives printing instructions for a held job from a user via the hold printing screen 700 displayed on the operation unit 140 of the image forming apparatus 10 (step S801). The CPU 101 determines whether or not the print job to which printing instructions have been given is a secure print job (step S802).

In the case where the print job to which printing instructions have been given is not a secure print job (NO at step S802), the CPU 101 attaches a new job ID to the print job (step S803). Then, the CPU 101 moves the job state to “processing start waiting” (step S804). The CPU 101 moves the job state to “processing in progress” (step S805) and performs printing processing of the print data (step S806). Then, after the printing processing is completed, the CPU 101 moves the job state to “completed” (step S807) and terminates the processing. As described above, in the case where the held print job is not a secure print job, a new ID is attached and printing is performed.

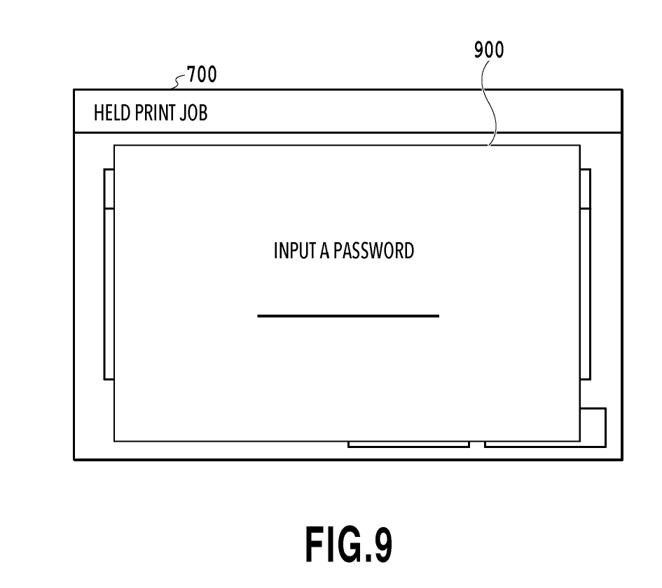

On the other hand, in the case where the print job to which printing instructions have been given is a secure print job (YES at step S802), the CPU 101 displays a screen (password input screen) to cause a user to input a password for secure printing on the operation unit 140 (step S808). In FIG. 9, an example of a password input screen is shown. In the case where a user inputs a password on a password input screen 900 shown in FIG. 9, the CPU 101 determines whether the input password and the password attached to the print job coincide with each other (step S809).

In the case where the passwords do not coincide with each other (NO at step S809), the CPU 101 returns to the processing at step S808 in order to prompt the user to input a password again. In the case where the passwords coincide with each other (YES at step S809), the CPU 101 advances to the processing at step S804. Then, the CPU 101 performs the processing at steps S804 to S807 and terminates the processing. As described above, in the case where the print job to which printing instructions have been given is a secure print job, the CPU 101 does not perform the processing at step S803. Due to this, in the case where the print job to which printing instructions have been given is a secure print job, a new job ID is not attached and the job ID attached at the time of reception of the print job (job ID attached at step S501) is used continuously. In the present embodiment, at step S501, in the case where the received print job is a secure print job, the CPU 101 causes the RAM 102 or the like to store the job ID attached to the secure print job. Then, the CPU 101 continuously uses the job ID that the RAM 102 or the like is caused to store in the processing at steps S804 to S807.

As described above, in the present embodiment, in the case where the hold printing mode is set to ON, on a condition that a secure print job is received, by continuously using the job ID, it is made possible to notify the side of the PC of the job state from the job reception of a secure print job until completion of printing. Consequently, according to the present embodiment, even in the case where the image forming apparatus has the hold printing function, it is made possible for a user to check the job state from the job input of a secure print job until completion of printing on a Print job monitor screen that is displayed on the side of the PC.

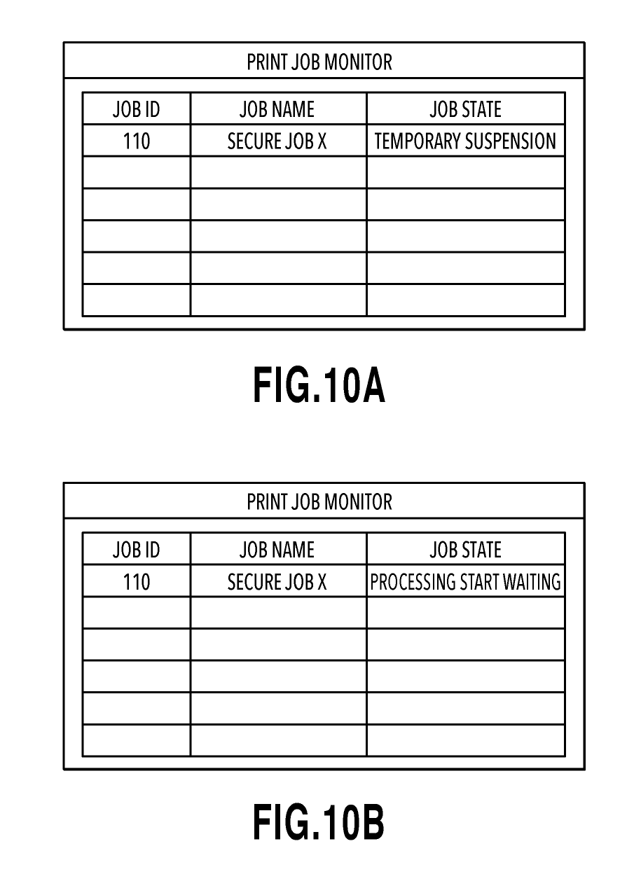

FIG. 10A shows a display example of the Print job monitor screen in the case where a secure print job (secure job X) is transmitted to the image forming apparatus 10 in the present embodiment. As shown in FIG. 10A, in the present embodiment, irrespective of whether the hold printing mode of the image forming apparatus 10 is ON or OFF, in the case where a secure print job is received, “temporary suspension” is displayed in the Job state column on the Print job monitor screen. Then, in the case where printing instructions are received for the secure print job (secure job X) during temporary suspension, in the Job state column on the Print job monitor screen, “processing start waiting” is displayed as shown in FIG. 10B. As described above, in the present embodiment, in the case where the print job to which printing instructions have been given is a secure print job, a new job ID is not attached. Consequently, in the Job ID column on the Print job monitor screen, the same ID (“110”) as the job ID shown in FIG. 10A is displayed. Due to this, even in the case where the hold printing mode of the image forming apparatus 10 is set to ON, it is made possible for a user to continuously check the job state of the secure print jog from job input until completion of printing on the Print job monitor screen.

### Second Embodiment

In the image forming apparatus having the hold printing function, there is a case where print data is kept in the storage area even after printing processing based on user instructions is completed in order to enable reprinting. However, as shown in the first embodiment, on the Print job monitor screen that is displayed on the display unit 25 of the PC 20, in the case where printing processing for a print job is completed, the display of the print job is deleted. Because of this, it is no longer possible to monitor the job state of the print job for which printing processing has been completed from the PC until reprinting is performed. Normally, a user desires to strictly monitor the job state of a secure print job. Consequently, in the case where the print job for which printing processing has been completed is a secure print job, an operation is desired, which does not keep the print data in the storage area by not permitting reprinting. Because of this, in the present embodiment, in the case where the print job is a secure print job, the print data is not kept in the storage area after printing is completed.

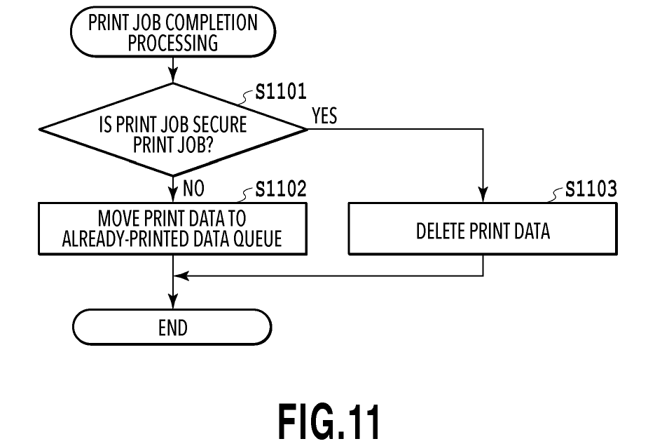

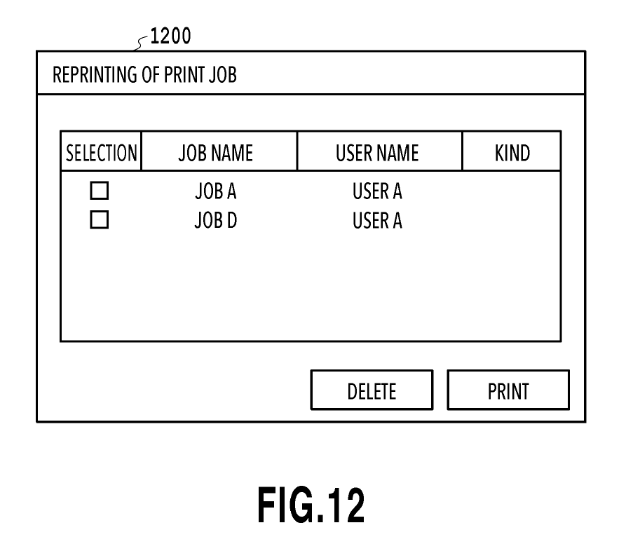

FIG. 11 is a flowchart showing processing at the time of completion of printing of a print job, which is performed by the CPU 101 of the image forming apparatus 10 according to the second embodiment. FIG. 12 is a diagram showing an example of a reprinting screen.

The CPU 101 determines whether or not the print job for which printing processing has been completed is a secure print job (step S1101). In the case of determining that the print job for which printing processing has been completed is not a secure print job (NO at step S1101), the CPU 101 moves the print data to an already-printed data queue (step S1102) and terminates the processing. An already-printed data queue is a storage area to save the print data for which printing processing has been completed and in the present embodiment, a partial area of the HDD 104 is used as an already-printed data queue. Reprinting from the already-printed data queue is performed upon receipt of instructions from a user via a reprinting screen 1200 shown in FIG. 12. The configuration of the reprinting screen 1200 is the same as the hold printing screen 700 shown in FIG. 7.

On the other hand, in the case where the print job for which printing processing has been completed is a secure print job (YES at step S1101), the CPU 101 deletes the print data (step S1103) and terminates the processing.

As described above, in the present embodiment, in the case where the print job for which printing processing has been completed is a secure print job, the print data of the print job is not kept in the storage area but deleted therefrom so that reprinting is not possible. Due to this, it is possible for a user to more strictly perform monitoring of a secure print job from the side of the PC.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In an image forming apparatus that operates in a hold printing mode, it is possible to appropriately notify the side of a PC of the job state of a print job for which secure printing setting has been performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-058088, filed Mar. 23, 2017, which is hereby incorporated by reference wherein in its entirety.

What is claimed is:

1. An image forming apparatus that receives print data from an external device and notifies the external device of a processing status of the print data and is capable of registering the print data so as to be capable of starting image formation based on the print data by printing instructions from a user and of notifying the external device of a first processing status of the print data in accordance with completion of the registration, the image forming apparatus comprising:
at least one controller having a processor that executes programs stored in a memory or a circuitry having functions implemented therein, the at least one controller being configured to function as:
a unit configured to, in a case of performing the registration for specific print data, notify the external device of a second processing status different from the first processing status.

2. The image forming apparatus according to claim 1, wherein
the first processing status is a processing status indicating completion of processing.

3. The image forming apparatus according to claim 1, wherein
the second processing status is a processing status indicating temporary suspension of processing.

4. The image forming apparatus according to claim 1, wherein
the second processing status is a processing status capable of receiving instructions to stop image formation from the external device and the first processing status is a processing status not capable of receiving instructions to stop image formation from the external device.

5. The image forming apparatus according to claim 1, wherein
the specific print data is print data for which secure printing setting has been performed.

6. The image forming apparatus according to claim 5, wherein
the unit determines that secure printing setting has been performed for the print data in a case where authentication information including a password is attached to the print data received from the external device.

7. The image forming apparatus according to claim 4, wherein
the unit deletes registration of the specific print data in a case where instructions to stop image formation are received in the second processing status.

8. The image forming apparatus according to claim 1, wherein
the unit allocates identification information capable of identifying the print data to the print data received from the external device and notifies the external device of the identification information along with the processing status, and
for the specific print data, the identification information allocated at the time of the reception is used continuously until image formation based on the specific print data is completed.

9. The image forming apparatus according to claim 1, wherein
the unit notifies the external device of the first processing status in a case where image formation based on the specific print data is completed.

10. The image forming apparatus according to claim 1, wherein
the unit deletes the specific print data in a case where image formation based on the specific print data is completed.

11. The image forming apparatus according to claim 1, wherein
the unit, in a case of determining that monitoring of print data is not being performed in the external device, notifies the external device of the first processing status even in the case of performing the registering for the specific print data.

12. The image forming apparatus according to claim 11, wherein
the unit determines whether or not monitoring of the print job is being performed in the device of source of transmission based on a kind of printing application used for transmission and reception of the print job.

13. A control method of an image forming apparatus that receives print data from an external device and notifies the external device of a processing status of the print data and is capable of registering the print data so as to be capable of starting image formation based on the print data by printing instructions from a user and of notifying the external device of a first processing status of the print data in accordance with completion of the registration, the method comprising:
a step of, in a case of performing the registration for specific print data, notifying the external device of a second processing status different from the first processing status.

14. A non-transitory computer readable storage medium storing a program for causing a computer to perform a control method of an image forming apparatus that receives print data from an external device and notifies the external device of a processing status of the print data and is capable of registering the print data so as to be capable of starting image formation based on the print data by printing instructions from a user and of notifying the external device of a first processing status of the print data in accordance with completion of the registration, the method comprising:
a step of, in a case of performing the registration for specific print data, notifying the external device of a second processing status different from the first processing status.
